(19) United States
(12) Patent Application Publication
(10) Pub. No.: US 2021/0140055 A1
(43) Pub. Date: May 13, 2021

(54) METHOD OF FORMING A DESIRED NITROGEN-CONTAINING COMPOUND

(71) Applicant: Georgia Tech Research Corporation, Atlanta, GA (US)

(72) Inventors: Marta Hatzell, Atlanta, GA (US); Benjamin M. Comer, Atlanta, GA (US); Andrew J. Medford, Atlanta, GA (US); James A. Townley, Atlanta, GA (US)

(21) Appl. No.: 17/254,941

(22) PCT Filed: Jun. 21, 2019
(86) PCT No.: PCT/US2019/038482

§ 371 Date: Dec. 22, 2020

Related U.S. Application Data
(60) Provisional application No. 62/688,904, filed on Jun. 22, 2018.

(51) Int. Cl. C25B 1/27; C25B 9/19; C25B 11/04; B01J 23/42; C01C 1/02

(52) U.S. Cl. CPC C25B 1/27; C25B 9/19; C01C 1/02; B01J 23/42; C25B 11/04

(57) ABSTRACT

Disclosed herein is a method of forming a desired nitrogen-containing compound, comprising: flowing a nitrogen source into an electrochemical cell, comprising: an anode, a cathode, and a catalyst material; reacting, at the anode, the nitrogen source in the presence of the catalyst material and a voltage; and forming, at the anode, the desired nitrogen-containing compound. Also disclosed herein is a method of forming a nitrogen-containing compound, comprising: providing an electrochemical cell, comprising: an anode, a cathode, and a catalyst material; obtaining nitrogen from a nitrogen source external to the electrochemical cell; flowing at least a portion of the nitrogen into the electrochemical cell; applying a voltage between the anode and the cathode; reacting, at the anode, the at least a portion of the nitrogen in the presence of the catalyst material; and forming, at the anode, the desired nitrogen-containing compound.

### CROSS-REFERENCE TO RELATED APPLICATIONS

This application claims the benefit of U.S. Provisional Patent Application No. 62/688,904, filed 22 Jun. 2018, the entire contents and substance of which is incorporated herein by reference in its entirety as if fully set forth below.

### FIELD OF THE DISCLOSURE

The present disclosure relates generally to nitrogen-containing compounds and methods of making the same. Particularly, embodiments of the present disclosure relate to methods of producing nitrogen-containing compounds in electrochemical cells.

### BACKGROUND

The U.S. Fertilizer industry generates more than $155 billion in economic benefit annually. Two major macronutrients found in all fertilizers are ammonia and nitrate, commonly referred to as fixed nitrogen. Production of fixed nitrogen-based nutrients takes place at large scales through the Haber-Bosch and Ostwald Processes. The key barrier these processes address is the ability to break the nitrogen triple bond found in naturally occurring gaseous elemental nitrogen (N₂), and subsequently oxidize or reduce elemental nitrogen to nitrate or ammonia. In order to do so, both processes employ elevated temperatures and pressures. These operational requirements often restrict nitrate and ammonia production to large centralize production facilities and, therefore, modularization for decentralization is not possible. Reduction of the harsh conditions needed for current nitrogen fixing processes would greatly expand the design space of many industries, such as farming, agriculture, fertilizers, forestry, botany, and the like. Improved food production and, by extension, better fertilization, are necessary to keep up with the predicted future population growth. Decentralization and modularization of nitrogen fixing processes are important to increase the amount of fixed nitrogen produced.

What is needed, therefore, are new methods of fixing nitrogen using more amicable conditions and smaller-scale process equipment. Embodiments of the present disclosure address this need as well as other needs that will become apparent upon reading the description below in conjunction with the drawings.

### BRIEF SUMMARY OF THE INVENTION

The present invention relates to solid electrolytes and methods of making the same. An exemplary embodiment of the present invention can provide a method of forming a desired nitrogen-containing compound, comprising: flowing a nitrogen source into an electrochemical cell, comprising: an anode, a cathode, and a catalyst material; reacting, at the anode, the nitrogen source in the presence of the catalyst material and a voltage; and forming, at the anode, the desired nitrogen-containing compound.

In any of the embodiments disclosed herein, the electrochemical cell can further comprise an electrolyte contained within the electrochemical cell operable to transport electrons between the anode and the cathode.

In any of the embodiments disclosed herein, the reacting can occur at a temperature from 20° C. to 300° C.

In any of the embodiments disclosed herein, the reacting can occur at 10 bar or less.

In any of the embodiments disclosed herein, the reacting can occur at ambient temperature and pressure.

In any of the embodiments disclosed herein, the electrochemical cell can be a liquid phase cell.

In any of the embodiments disclosed herein, the flowing the nitrogen source can comprise bubbling air through the electrolyte to saturate the electrolyte with the air.

In any of the embodiments disclosed herein, the electrolyte can comprise an aqueous electrolyte.

In any of the embodiments disclosed herein, the aqueous electrolyte can be an alkaline solution.

In any of the embodiments disclosed herein, the aqueous electrolyte can be an acidic solution.

In any of the embodiments disclosed herein, the electrochemical cell can be a gas phase cell.

In any of the embodiments disclosed herein, the flowing the nitrogen source can comprise contacting air with the electrolyte.

In any of the embodiments disclosed herein, the electrolyte can comprise a solid electrolyte.

In any of the embodiments disclosed herein, the solid electrolyte can comprise a polymer.

In any of the embodiments disclosed herein, the electrolyte can comprise a ceramic.

In any of the embodiments disclosed herein, the catalyst material can be disposed on the anode.

In any of the embodiments disclosed herein, the catalyst material can be a semiconductor.

In any of the embodiments disclosed herein, the voltage can be provided by a light source operable to excite electrons in the semiconductor.

In any of the embodiments disclosed herein, the reacting can comprise a redox reaction.

In any of the embodiments disclosed herein, the desired nitrogen-containing compound can comprise ammonia.

In any of the embodiments disclosed herein, the desired nitrogen-containing compound can comprise a nitrate.

Another embodiment of the present disclosure can provide a method of forming a nitrogen-containing compound, comprising: providing an electrochemical cell, comprising: an anode, a cathode, and a catalyst material; obtaining nitrogen from a nitrogen source external to the electrochemical cell; flowing at least a portion of the nitrogen into the electrochemical cell; applying a voltage between the anode and the cathode; reacting, at the anode, the at least a portion of the nitrogen in the presence of the catalyst material; and forming, at the anode, the desired nitrogen-containing compound.

In any of the embodiments disclosed herein, the electrochemical cell can further comprise an electrolyte contained within the electrochemical cell operable to transport electrons between the anode and the cathode.

In any of the embodiments disclosed herein, wherein the reacting can occur at a temperature from 20° C. to 300° C.

In any of the embodiments disclosed herein, the reacting can occur at 10 bar or less.

In any of the embodiments disclosed herein, the reacting can occur at ambient temperature and pressure.

In any of the embodiments disclosed herein, the electrochemical cell can be a liquid phase cell.

In any of the embodiments disclosed herein, the flowing the nitrogen source can comprise bubbling air through the electrolyte to saturate the electrolyte with the air.

In any of the embodiments disclosed herein, the electrolyte can comprise an aqueous electrolyte.

In any of the embodiments disclosed herein, the aqueous electrolyte can be an alkaline solution.

In any of the embodiments disclosed herein, the aqueous electrolyte can be an acidic solution.

In any of the embodiments disclosed herein, the electrochemical cell can be a gas phase cell.

In any of the embodiments disclosed herein, the flowing the nitrogen source can comprise contacting air with the electrolyte.

In any of the embodiments disclosed herein, the electrolyte can comprise a solid electrolyte.

In any of the embodiments disclosed herein, the solid electrolyte can comprise a polymer.

In any of the embodiments disclosed herein, the electrolyte can comprise a ceramic.

In any of the embodiments disclosed herein, the catalyst material can be disposed on the anode.

In any of the embodiments disclosed herein, the catalyst material can be a semiconductor.

In any of the embodiments disclosed herein, the voltage can be provided by a light source operable to excite electrons in the semiconductor.

In any of the embodiments disclosed herein, the desired nitrogen-containing compound can comprise ammonia.

In any of the embodiments disclosed herein, the desired nitrogen-containing compound can comprise a nitrate.

These and other aspects of the present invention are described in the Detailed Description of the Invention below and the accompanying figures. Other aspects and features of embodiments of the present invention will become apparent to those of ordinary skill in the art upon reviewing the following description of specific, exemplary embodiments of the present invention in concert with the figures. While features of the present invention may be discussed relative to certain embodiments and figures, all embodiments of the present invention can include one or more of the features discussed herein. Further, while one or more embodiments may be discussed as having certain advantageous features, one or more of such features may also be used with the various embodiments of the invention discussed herein. In similar fashion, while exemplary embodiments may be discussed below as device, system, or method embodiments, it is to be understood that such exemplary embodiments can be implemented in various devices, systems, and methods of the present invention.

### BRIEF DESCRIPTION OF THE DRAWINGS

The accompanying drawings, which are incorporated in and constitute a part of this specification, illustrate multiple embodiments of the presently disclosed subject matter and serve to explain the principles of the presently disclosed subject matter. The drawings are not intended to limit the scope of the presently disclosed subject matter in any manner.

FIG. 1 illustrates a method of forming a desired nitrogen-containing compound according to some embodiments of the present disclosure;

FIG. 2 illustrates the production rate of a desired nitrogen-containing material for several catalyst materials according to some embodiments of the present disclosure;

FIG. 3a is a plot of amount of desired nitrogen-containing material produced by a method according to some embodiments of the present disclosure versus production time;

FIG. 3b is a plot of amount of desired nitrogen-containing material produced by a method according to some embodiments of the present disclosure versus production time;

FIG. 4a is a plot of current versus cathode potential for an electrochemical cell according to some embodiments of the present disclosure;

FIG. 4b is a plot of current density over time at several voltages for an electrochemical cell according to some embodiments of the present disclosure;

FIG. 5a is a plot of production rate of desired nitrogen-containing material versus voltage of an electrochemical cell according to some embodiments of the present disclosure;

FIG. 5b is a plot of Faradaic Efficiency versus voltage of an electrochemical cell according to some embodiments of the present disclosure;

FIG. 6 is a flowchart of a method for making a desired nitrogen-containing compound according to some embodiments of the present disclosure; and

FIG. 7 is a flowchart of a method for making a desired nitrogen-containing compound according to some embodiments of the present disclosure.

### DETAILED DESCRIPTION

Although certain embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. Other embodiments of the disclosure are capable of being practiced or carried out in various ways. Also, in describing the embodiments, specific terminology will be resorted to for the sake of clarity. It is intended that each term contemplates its broadest meaning as understood by those skilled in the art and includes all technical equivalents which operate in a similar manner to accomplish a similar purpose.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

As described above, a problem with current methods of producing nitrogen-containing compounds is the massive energy requirements and harsh conditions required to break the triple bond present in elemental nitrogen, and subsequently oxidize or reduce nitrogen to nitrate or ammonia. It is desirable to have less energy-intensive processes with smaller process equipment and modular, decentralized production. Reduction of the harsh conditions needed for current nitrogen fixing processes would greatly expand the design space of many industries, such as farming, agriculture, fertilizers, forestry, botany, and the like. Improved food production and, by extension, better fertilization, are necessary to keep up with the predicted future population growth. Decentralization and modularization of nitrogen fixing processes are important to increase the amount of fixed nitrogen produced.

Electrochemical processes operate at low temperatures and pressures, sometimes near ambient, and have the advantage of operating potentially with renewable energy. Traditionally, nitrogen fixation involved a two-step method of first reducing elemental nitrogen to ammonia, followed by oxidizing the ammonia to nitrate. Electrochemical processes, however, can oxidize elemental nitrogen and convert pure nitrogen straight to nitrate without intermediate steps. Such an embodiment provides for the intake of abundant nitrogen sources, such as nitrogen impurities in water or air, and subsequent conversion to desired nitrates at near-ambient conditions. Thus, operating and energy costs can be reduced, and nitrogen fixation processes can be decentralized to smaller processing facilities. The abundance of nitrogen sources combined with the potential to be powered by renewable energy, such as in FIG. 1, would make the disclosed processes for fixing nitrogen crucial for future development.

Disclosed herein are methods for forming a desired nitrogen-containing compound. Nitrogen can be taken from a nitrogen source, such as impurities in water, air, or pure nitrogen, and passed through an electrochemical cell. The electrochemical cell can either be a liquid phase or a gas phase cell with an anode, a cathode, and a catalyst material. In some embodiments, an electrolyte can be present to flow electrons in between the anode and the cathode. As a voltage is applied to the cell, and nitrogen flows through the cell, the electrochemical reaction can drive the conversion of nitrogen to the desired compounds. The presence of a catalyst contacting the nitrogen can further aid in the reaction. In a liquid or aqueous phase cell, the nitrogen source can be bubbled through the cell to saturate the electrolyte. The voltage supplied to the cell can come from an electric source connected to the anode and the cathode.

In a gas phase cell, gaseous nitrogen can simply be flowed through the cell and contacted with the catalyst. In such an embodiment, there may be no need for an electrolyte, as the nitrogen can contact the reactive surface in the presence of the catalyst. In some embodiments, the reaction can be activated by light. The catalyst material can be a semiconductor, and the presence of light may activate the catalyst material to excite electrons and begin driving the reaction. While the gas and liquid phase cells have their differences, the outcome remains the same; the movement of electrons with a catalyst will drive the conversion of nitrogen sources to desired forms of nitrogen through a redox reaction. In both examples, the reaction and entire process may occur at relatively low temperature and pressure—sometimes near-ambient conditions. The embodiments disclosed herein can offer that advantage over the prior art, substantially lowering the barriers to nitrogen fixation and increasing the ease of production of related nitrogen-containing compounds.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

FIGS. 6-7 illustrate exemplary embodiments of the presently disclosed method of forming a desired nitrogen-containing compound.

In FIG. 6, a method of forming a desired nitrogen-containing compound is illustrated. In block 610, a nitrogen source can be flowed into an electrochemical cell. Suitable examples of a nitrogen source can include, but are not limited to, air, pure nitrogen, water impurities, fertilizer, nitric acid, nitrate-based compounds, and the like. As used herein the terms “pure nitrogen” or “elemental nitrogen” refer to the naturally occurring state of nitrogen, dinitrogen (N₂). In some embodiments, the flowing can be bubbling, sparging, aerating, contacting, and the like. For example, pure nitrogen can be flowed into an electrochemical cell and contacted with the cell.

In some embodiments, the electrochemical cell can comprise an anode, a cathode, and a catalyst material. The electrochemical cell may be a liquid phase cell or a gas phase cell. The anode and the cathode may comprise a metal. Suitable examples of a metal can include, but are not limited to, graphite, silver, copper, gold, aluminum, calcium, tungsten, zinc, nickel, lithium, iron, platinum, tin, gallium, niobium, steel, carbon steel, lead, titanium, electrical steel, manganin, constantan, stainless steel, mercury, manganese, amorphous carbon, germanium and the like. The anode and the cathode can be in the form of a mesh, a plate, a disc, and the like capable of providing a reactive surface for the nitrogen source. In some embodiments, the catalyst material may be disposed on the anode. Suitable examples of a catalyst material can include conductive materials, such as graphite, silver, copper, gold, aluminum, calcium, tungsten, zinc, nickel, lithium, iron, platinum, tin, gallium, niobium, steel, carbon steel, lead, titanium, electrical steel, manganin, constantan, stainless steel, mercury, manganese, amorphous carbon, germanium and the like. Production rates of nitrogen-containing compounds using several suitable examples of a catalyst material can be seen in FIG. 2. Additionally, plots of production amount over time are shown for ammonium from pure elemental nitrogen, as shown in FIG. 3a, and ammonium from an inert atmosphere such as argon, as shown in FIG. 3b. In some embodiments, the catalyst material may be a semiconductor, such as titanium oxides, tin oxides, silicon, silicon oxides, zirconium oxides, molybdenum oxides, manganese oxides, iron oxides, and the like. Additionally, the catalyst material may be such materials as rhenium oxide, tantalum oxide, osmium oxide, iridium oxide, vanadium oxide, niobium oxide, ruthenium oxide, platinum oxide, rhodium oxide, chromium oxide, titanium oxide and manganese oxide (among the others already mentioned). In some embodiments, the catalyst material may comprise oxides, carbides, nitrides, phosphates, phosphides, borides, and other transition-metal compounds formed from rhenium, tantalum, osmium, iridium, vanadium, niobium, ruthenium, platinum, rhodium, chromium, titanium, manganese, molybdenum, zirconium, tin, or other metals. The catalyst material may also be any photo-active material capable of producing electrons in an excited state when in the presence of light. When using a photo-active material, individual atoms may act as the cathode and the anode. In other words, a single atom may act as an “anode” and a different single atom on the same surface but at a different location may be the “cathode.” In some embodiments, the catalytic activity may be enhanced by the intentional introduction of defects including oxygen vacancies, metal vacancies, or substitutions with carbon, nitrogen, phosphorous, or other p-block metals.

In some embodiments, the electrochemical cell may further comprise an electrolyte contained within the electrochemical cell. For example, the electrolyte may be contained between the anode and the cathode. In a liquid phase cell, the electrolyte may be saturated by the nitrogen source. In a solid phase cell, the electrolyte may be between the anode and cathode and simply contact the nitrogen source. The electrolyte may be capable of transporting electrons between the anode and the cathode. The electrolyte may be a solid electrolyte or an aqueous electrolyte. Suitable examples of an aqueous electrolyte can include, but are not limited to, alkaline solutions and acidic solutions, such as lithium perchlorate or potassium perchlorate. Suitable examples of a solid electrolyte can include, but are not limited to, polymers and ceramics. Other examples of an electrolyte can include, but are not limited to, lithium perchlorate, sodium chloride, lithium phosphate, potassium hydroxide, and the like. In some embodiments, the electrochemical cell may further comprise a membrane to separate the anode from the cathode while allowing the electrolyte and electrons to pass through.

In block 620, the nitrogen source can be reacted at the anode in the presence of the catalyst material by applying a voltage to the electrochemical cell. The voltage applied to the cell can come from an electrical source and an electrical potential applied between the anode and the cathode, or the voltage can be provided by the excitement of electrons from a catalyst material. As used herein, the term “voltage” will refer to a transfer of electrons between an anode and a cathode by any means, including when the anode and the cathode are different atoms of the same surface. The examples of electric potential and photo-activated electron excitement are provided solely for illustration, and not limitation. As would be appreciated by one of ordinary skill in the art, the transfer of electrons in the electrochemical cell is the driving force behind the reaction. When the nitrogen source comes into contact with the reactive surface at the anode, either by saturating the electrolyte or by simply flowing the gas over the anode, the reaction can occur.

In some embodiments, the reacting can occur at 20° C. or greater (e.g., 25° C. or greater, 30° C. or greater, 40° C. or greater, 50° C. or greater, 60° C. or greater, 70° C. or greater, 80° C. or greater, 90° C. or greater, 100° C. or greater, 110° C. or greater, 120° C. or greater, 130° C. or greater, 140° C. or greater, 150° C. or greater, 160° C. or greater, 170° C. or greater, 180° C. or greater, 190° C. or greater, 200° C. or greater, 210° C. or greater, 220° C. or greater, 230° C. or greater, 240° C. or greater, 250° C. or greater, 260° C. or greater, 270° C. or greater, 280° C. or greater, 290° C. or greater, or 300° C. or greater).

Additionally, or alternatively, in some embodiments, the reacting can occur at 300° C. or less (e.g., 20° C. or less, 25° C. or less, 30° C. or less, 40° C. or less, 50° C. or less, 60° C. or less, 70° C. or less, 80° C. or less, 90° C. or less, 100° C. or less, 110° C. or less, 120° C. or less, 130° C. or less, 140° C. or less, 150° C. or less, 160° C. or less, 170° C. or less, 180° C. or less, 190° C. or less, 200° C. or less, 210° C. or less, 220° C. or less, 230° C. or less, 240° C. or less, 250° C. or less, 260° C. or less, 270° C. or less, 280° C. or less, or 290° C. or less).

In some embodiments, the reacting can occur from 20° C. to 300° C. (e.g., from 25° C. to 295° C., from 30° C. to 290° C., from 40° C. to 280° C., from 50° C. to 270° C., from 60° C. to 260° C., from 70° C. to 250° C., from 80° C. to 240° C., from 90° C. to 230° C., from 100° C. to 220° C., from 110° C. to 210° C., from 25° C. to 100° C., from 25° C. to 50° C., from 20° C. to 100° C., from 20° C. to 50° C., from 20° C. to 250° C., or from 25° C. to 250° C.).

In some embodiments, the reacting can occur at 1 bar or greater (e.g., 1.5 bar or greater, 2 bar or greater, 2.5 bar or greater, 3 bar or greater, 3.5 bar or greater, 4 bar or greater, 4.5 bar or greater, 5 bar or greater, 5.5 bar or greater, 6 bar or greater, 6.5 bar or greater, 7 bar or greater, 7.5 bar or greater, 8 bar or greater, 8.5 or greater, 9 bar or greater, 9.5 bar or greater, or 10 bar or greater).

Additionally or alternatively, in some embodiments, the reacting can occur at 10 bar or less (e.g., 1 bar or less, 1.5 bar or less, 2 bar or less, 2.5 bar or less, 3 bar or less, 3.5 bar or less, 4 bar or less, 4.5 bar or less, 5 bar or less, 5.5 bar or less, 6 bar or less, 6.5 bar or less, 7 bar or less, 7.5 bar or less, 8 bar or less, 8.5 or less, 9 bar or less, or 9.5 bar or less).

In some embodiments, the reacting can occur from 1 bar to 10 bar (e.g., from 1.5 bar to 9.5 bar, from 2 bar to 9 bar, from 2.5 bar to 8.5 bar, from 3 bar to 8 bar, from 3.5 bar to 7.5 bar, from 4 bar to 7 bar, from 1 bar to 5 bar, from 1 bar to 2 bar, from 1 bar to 4 bar, from 1.5 bar to 5 bar, or from 1 bar to 1.5 bar).

In some embodiments, the reacting can last for 1 hour or greater (e.g., 1.5 hours or greater, 2 hours or greater, 2.5 hours or greater, 3 hours or greater, 3.5 hours or greater, 4 hours or greater, 4.5 hours or greater, 5 hours or greater, 6 hours or greater, 7 hours or greater, 8 hours or greater, 9 hours or greater, 10 hours or greater, 11 hours or greater, 12 hours or greater, 13 hours or greater, 14 hours or greater, 15 hours or greater, 16 hours or greater, 17 hours or greater, 18 hours or greater, 19 hours or greater, 20 hours or greater, 21 hours or greater, 22 hours or greater, 23 hours or greater, or 24 hours or greater).

Additionally or alternatively, in some embodiments, the reacting can last for 24 hours or less (e.g., 1 hours or less, 1.5 hours or less, 2 hours or less, 2.5 hours or less, 3 hours or less, 3.5 hours or less, 4 hours or less, 4.5 hours or less, 5 hours or less, 6 hours or less, 7 hours or less, 8 hours or less, 9 hours or less, 10 hours or less, 11 hours or less, 12 hours or less, 13 hours or less, 14 hours or less, 15 hours or less, 16 hours or less, 17 hours or less, 18 hours or less, 19 hours or less, 20 hours or less, 21 hours or less, 22 hours or less, or 23 hours or less).

In some embodiments, the reacting can last from 1 hour to 24 hours (e.g., from 1.5 hours to 23 hours, from 2 hours to 22 hours, from 2.5 hours to 21 hours, from 3 hours to 20 hours, from 4 hours to 19 hours, from 5 hours to 18 hours, from 5 hours to 17 hours, from 5 hours to 16 hours, from 1 hour to 16 hours, from 1 hour to 12 hours, from 1 hour to 8 hours, or from 1 hour to 5 hours).

In block 630, a desired nitrogen-containing compound can be formed as a product of the reaction occurring in block 620. It is understood that other products may be present. Suitable examples of a nitrogen-containing compound can include, but are not limited to, ammonia, ammonium, nitric acid, nitrate, nitrous acid, nitrogen dioxide, nitrogen monoxide, nitrous oxide, peroxynitric acid, hyponitrous acid, hydronitric acid, and the like. In some embodiments, the desired nitrogen-containing compound may be any oxidized form of nitrogen.

In FIG. 7, a method of forming a desired nitrogen-containing compound is illustrated. In block 710, an electrochemical cell can be provided, comprising an anode, a cathode, and a catalyst material. The electrochemical cell may be a liquid phase cell or a gas phase cell. The anode and the cathode may comprise a metal. Suitable examples of a metal can include, but are not limited to, graphite, silver, copper, gold, aluminum, calcium, tungsten, zinc, nickel, lithium, iron, platinum, tin, gallium, niobium, steel, carbon steel, lead, titanium, electrical steel, manganin, constantan, stainless steel, mercury, manganese, amorphous carbon, germanium and the like. The anode and the cathode can be in the form of a mesh, a plate, a disc, and the like capable of providing a reactive surface for the nitrogen source. In some embodiments, the catalyst material may be disposed on the anode. Suitable examples of a catalyst material can include conductive materials, such as titanium oxides. Additional examples are contemplated and described above regarding FIG. 6. Suitable examples of a catalyst material can include conductive materials, such as graphite, silver, copper, gold, aluminum, calcium, tungsten, zinc, nickel, lithium, iron, platinum, tin, gallium, niobium, steel, carbon steel, lead, titanium, electrical steel, manganin, constantan, stainless steel, mercury, manganese, amorphous carbon, germanium and the like. In some embodiments, the catalyst material may be a semiconductor, such as titanium oxides, tin oxides, silicon, silicon oxides, zirconium oxides, molybdenum oxides, manganese oxides, iron oxides, and the like. Additionally, the catalyst material may be such materials as rhenium oxide, tantalum oxide, osmium oxide, iridium oxide, vanadium oxide, niobium oxide, ruthenium oxide, platinum oxide, rhodium oxide, chromium oxide, titanium oxide and manganese oxide (among the others already mentioned). In some embodiments, the catalyst material may comprise oxides, carbides, nitrides, phosphates, phosphides, borides, and other transition-metal compounds formed from rhenium, tantalum, osmium, iridium, vanadium, niobium, ruthenium, platinum, rhodium, chromium, titanium, manganese, molybdenum, zirconium, tin, or other metals. The catalyst material may also be any photo-active material capable of producing electrons in an excited state when in the presence of light. When using a photo-active material, individual atoms may act as the cathode and the anode. In other words, a single atom may act as an “anode” and a different single atom on the same surface but at a different location may be the “cathode.” In some embodiments, the catalytic activity may be enhanced by the intentional introduction of defects including oxygen vacancies, metal vacancies, or substitutions with carbon, nitrogen, phosphorous, or other p-block metals.

In some embodiments, the electrochemical cell may further comprise an electrolyte contained within the electrochemical cell. For example, the electrolyte may be contained between the anode and the cathode. In a liquid phase cell, the electrolyte may be saturated by the nitrogen source. In a solid phase cell, the electrolyte may be between the anode and cathode and simply contact the nitrogen source. The electrolyte may be capable of transporting electrons between the anode and the cathode. The electrolyte may be a solid electrolyte or an aqueous electrolyte. Suitable examples of an aqueous electrolyte can include, but are not limited to, alkaline solutions and acidic solutions, such as lithium perchlorate or potassium perchlorate. Suitable examples of a solid electrolyte can include, but are not limited to, polymers and ceramics. Other examples of an electrolyte can include, but are not limited to, lithium perchlorate, sodium chloride, lithium phosphate, potassium hydroxide, and the like. In some embodiments, the electrochemical cell may further comprise a membrane to separate the anode from the cathode while allowing the electrolyte and electrons to pass through.

In block 720, nitrogen can be obtained from a nitrogen source external to the electrochemical cell. Suitable examples of a nitrogen source can include, but are not limited to, air, pure nitrogen, water impurities, fertilizer, nitric acid, nitrate-based compounds, and the like. The obtained nitrogen can be in the form of elemental nitrogen or may be in the form of other nitrogen-based compounds.

In block 730, at least a portion of the obtained nitrogen can be flowed into the electrochemical cell. In some embodiments, the flowing can be bubbling, sparging, aerating, contacting, and the like. For example, pure nitrogen can be flowed into an electrochemical cell and contacted with the cell.

In block 740, a voltage can be applied to the electrochemical cell. The voltage applied to the cell can come from an electrical source and an electrical potential applied between the anode and the cathode, or the voltage can be provided by the excitement of electrons from a catalyst material. As used herein, the term “voltage” will refer to a transfer of electrons between an anode and a cathode by any means, including when the anode and the cathode are different atoms of the same surface. The examples of electric potential and photo-activated electron excitement are provided solely for illustration, and not limitation. As would be appreciated by one of ordinary skill in the art, the transfer of electrons in the electrochemical cell is the driving force behind the reaction. When the nitrogen source comes into contact with the reactive surface at the anode, either by saturating the electrolyte or by simply flowing the gas over the anode, the reaction can occur, and thus the method can progress to block 750.

In block 750, the at least a portion of the obtained nitrogen can be reacted at the anode in the presence of the catalyst material. In some embodiments, the reaction can be a redox reaction and can oxidize the nitrogen in the electrochemical cell.

In some embodiments, the reacting can occur at 20° C. or greater (e.g., 25° C. or greater, 30° C. or greater, 40° C. or greater, 50° C. or greater, 60° C. or greater, 70° C. or greater, 80° C. or greater, 90° C. or greater, 100° C. or greater, 110° C. or greater, 120° C. or greater, 130° C. or greater, 140° C. or greater, 150° C. or greater, 160° C. or greater, 170° C. or greater, 180° C. or greater, 190° C. or greater, 200° C. or greater, 210° C. or greater, 220° C. or greater, 230° C. or greater, 240° C. or greater, 250° C. or greater, 260° C. or greater, 270° C. or greater, 280° C. or greater, 290° C. or greater, or 300° C. or greater).

Additionally or alternatively, in some embodiments, the reacting can occur at 300° C. or less (e.g., 20° C. or less, 25° C. or less, 30° C. or less, 40° C. or less, 50° C. or less, 60° C. or less, 70° C. or less, 80° C. or less, 90° C. or less, 100° C. or less, 110° C. or less, 120° C. or less, 130° C. or less, 140° C. or less, 150° C. or less, 160° C. or less, 170° C. or less, 180° C. or less, 190° C. or less, 200° C. or less, 210° C. or less, 220° C. or less, 230° C. or less, 240° C. or less, 250° C. or less, 260° C. or less, 270° C. or less, 280° C. or less, or 290° C. or less).

In some embodiments, the reacting can occur from 20° C. to 300° C. (e.g., from 25° C. to 295° C., from 30° C. to 290° C., from 40° C. to 280° C., from 50° C. to 270° C., from 60° C. to 260° C., from 70° C. to 250° C., from 80° C. to 240° C., from 90° C. to 230° C., from 100° C. to 220° C., from 110° C. to 210° C., from 25° C. to 100° C., from 25° C. to 50° C., from 20° C. to 100° C., from 20° C. to 50° C., from 20° C. to 250° C., or from 25° C. to 250° C.).

In some embodiments, the reacting can occur at 1 bar or greater (e.g., 1.5 bar or greater, 2 bar or greater, 2.5 bar or greater, 3 bar or greater, 3.5 bar or greater, 4 bar or greater, 4.5 bar or greater, 5 bar or greater, 5.5 bar or greater, 6 bar or greater, 6.5 bar or greater, 7 bar or greater, 7.5 bar or greater, 8 bar or greater, 8.5 or greater, 9 bar or greater, 9.5 bar or greater, or 10 bar or greater).

Additionally or alternatively, in some embodiments, the reacting can occur at 10 bar or less (e.g., 1 bar or less, 1.5 bar or less, 2 bar or less, 2.5 bar or less, 3 bar or less, 3.5 bar or less, 4 bar or less, 4.5 bar or less, 5 bar or less, 5.5 bar or less, 6 bar or less, 6.5 bar or less, 7 bar or less, 7.5 bar or less, 8 bar or less, 8.5 or less, 9 bar or less, or 9.5 bar or less).

In some embodiments, the reacting can occur from 1 bar to 10 bar (e.g., from 1.5 bar to 9.5 bar, from 2 bar to 9 bar, from 2.5 bar to 8.5 bar, from 3 bar to 8 bar, from 3.5 bar to 7.5 bar, from 4 bar to 7 bar, from 1 bar to 5 bar, from 1 bar to 2 bar, from 1 bar to 4 bar, from 1.5 bar to 5 bar, or from 1 bar to 1.5 bar).

In some embodiments, the reacting can last for 1 hour or greater (e.g., 1.5 hours or greater, 2 hours or greater, 2.5 hours or greater, 3 hours or greater, 3.5 hours or greater, 4 hours or greater, 4.5 hours or greater, 5 hours or greater, 6 hours or greater, 7 hours or greater, 8 hours or greater, 9 hours or greater, 10 hours or greater, 11 hours or greater, 12 hours or greater, 13 hours or greater, 14 hours or greater, 15 hours or greater, 16 hours or greater, 17 hours or greater, 18 hours or greater, 19 hours or greater, 20 hours or greater, 21 hours or greater, 22 hours or greater, 23 hours or greater, or 24 hours or greater).

Additionally or alternatively, in some embodiments, the reacting can last for 24 hours or less (e.g., 1 hours or less, 1.5 hours or less, 2 hours or less, 2.5 hours or less, 3 hours or less, 3.5 hours or less, 4 hours or less, 4.5 hours or less, 5 hours or less, 6 hours or less, 7 hours or less, 8 hours or less, 9 hours or less, 10 hours or less, 11 hours or less, 12 hours or less, 13 hours or less, 14 hours or less, 15 hours or less, 16 hours or less, 17 hours or less, 18 hours or less, 19 hours or less, 20 hours or less, 21 hours or less, 22 hours or less, or 23 hours or less).

In some embodiments, the reacting can last from 1 hour to 24 hours (e.g., from 1.5 hours to 23 hours, from 2 hours to 22 hours, from 2.5 hours to 21 hours, from 3 hours to 20 hours, from 4 hours to 19 hours, from 5 hours to 18 hours, from 5 hours to 17 hours, from 5 hours to 16 hours, from 1 hour to 16 hours, from 1 hour to 12 hours, from 1 hour to 8 hours, or from 1 hour to 5 hours).

In block 760, the desired nitrogen-containing compound can be formed at the anode as a result of the reaction in 750. It is understood that other products may be present. Suitable examples of a nitrogen-containing compound can include, but are not limited to, ammonia, ammonium, nitric acid, nitrate, nitrous acid, nitrogen dioxide, nitrogen monoxide, nitrous oxide, peroxynitric acid, hyponitrous acid, hydronitric acid, and the like. In some embodiments, the desired nitrogen-containing compound may be any oxidized form of nitrogen.

Reference will now be made in detail to exemplary embodiments of the disclosed technology, examples of which are illustrated in the accompanying drawings and disclosed herein.

### EXAMPLES

The following examples are provided by way of illustration but not by way of limitation.

### Example 1

### Materials and Methods

Platinum mesh electrodes, lithium perchlorate, and potassium perchlorate were purchased from Sigma Aldrich. Gases with ultra-high purity (UHP Grade 5) were purchased from Airgas.

Electrochemical cells (h-cells) were made with a membrane placed in between the anode and cathode. The cathode and anode both comprised platinum mesh electrodes. The whole cell was poised at various set electric potentials for a range of different time scales in a lithium perchlorate and potassium perchlorate electrolyte while bubbling air through the cathode compartment. The anode potential was simultaneously measured compared to a Ag/AgCl reference. At the end of testing, the electrolyte was analyzed using ion chromatography. In all cases, nitrate was detected with larger amounts measured at longer reaction times and higher voltages.

### Example 2

### Materials and Methods

Photocatalysis was carried out under 450 W ultraviolet light with a catalyst solution having a density of 1 g/L. FIG. 3a shows the ammonium production yield of the different catalyst materials corresponding to various times. FIG. 3b shows the ammonium production yield of the different catalyst materials using an inert atmosphere comprising argon. FIG. 2 displays the production rates of the various catalysts.

Cyclic voltammetry and chronomperometry of planar gold electrodes in the presence of pure nitrogen were taken using a 0.5 M lithium perchlorate electrolyte. The relationship between current density and cathode potential is shown in FIG. 4a, and the current density over time for various electric potentials can be seen in FIG. 4b. The production rate and Faradaic efficiency of ammonia at various potentials in a range from −1.7 V to −0.8 V was determined using a 0.5 M lithium perchlorate electrolyte. The planar gold electrode in the presence of pure nitrogen produced small amounts of ammonia with magnitudes comparable to routine instrument noise. In the presence of argon gas, no ammonia was observed. The production rate, as shown in FIG. 5a, follows a linear trend and increased as the cathode potential moves increasingly negative. The Faradaic efficiency, as shown in FIG. 5b, increased exponentially as the cathode potential magnitude decreased. This can be attributed to the exponential increase in the hydrogen evolution reaction (HER) activity with cathode potentials below −1.1 V. The high Faradic efficiency at −0.8 V can be attributed to the small current densities experienced at this potential.

While the present disclosure has been described in connection with a plurality of exemplary aspects, as illustrated in the various figures and discussed above, it is understood that other similar aspects can be used or modifications and additions can be made to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. Instead, it is intended that the invention is defined by the claims appended hereto.

1. A method of forming a nitrogen-containing compound comprising:
bubbling a nitrogen source through an electrolyte of an electrochemical cell;
reacting the nitrogen source in the presence of a catalyst material and a voltage; and
forming the nitrogen-containing compound.

2. The method of claim 1, wherein the electrolyte is operable to transport electrons between an anode and a cathode of the electrochemical cell; and
wherein the reacting and the forming occur at the anode.

3. The method of claim 2, wherein the reacting occurs at a temperature from 20° C. to 300° C.

4. The method of claim 2, wherein the reacting occurs at 10 bar or less.

5. The method of claim 2, wherein the reacting occurs at ambient temperature and pressure.

6. The method of claim 2, wherein the electrochemical cell is a liquid phase cell.

7. The method of claim 2, wherein the reacting yields one or more products in addition to the nitrogen-containing compound; and
wherein none of the one or more products comprise ammonia.

8. The method of claim 7, wherein the reacting occurs at a temperature from 20° C. to 300° C.

9. The method of claim 8, wherein the reacting occurs at 10 bar or less.

10. The method of claim 7, wherein the reacting occurs at ambient temperature and pressure

11. The method of claim 7, wherein the electrochemical cell is a gas phase cell.

12. The method of claim 11, wherein the nitrogen source comprises air.

13. The method of claim 11, wherein the electrolyte comprises a solid electrolyte.

14. The method of claim 13, wherein the solid electrolyte comprises a polymer.

15. The method of claim 13, wherein the electrolyte comprises a ceramic.

16. (canceled)

17. The method of claim 7, wherein the catalyst material is a semiconductor.

18. The method of claim 17, wherein the voltage is provided by a light source operable to excite electrons in the semiconductor.

19.-21. (canceled)

22. A method of forming a nitrogen-containing compound comprising:
obtaining nitrogen from a nitrogen source;
flowing at least a portion of the nitrogen into an electrochemical cell;
applying a voltage between an anode and a cathode of the electrochemical cell;
reacting, at the anode, at least a portion of the nitrogen in the presence of a catalyst material of the electrochemical cell; and
forming, at the anode, the nitrogen-containing compound.

23. The method of claim 22, wherein no products or intermediate products of the reacting comprise ammonia.

24. The method of claim 23, wherein the reacting occurs at a temperature from 20° C. to 300° C.

25. The method of claim 23, wherein the reacting occurs at 10 bar or less.

26. The method of claim 23, wherein the reacting occurs at ambient temperature and pressure.

27. The method of claim 23, wherein the electrochemical cell is a liquid phase cell.

28. The method of claim 27, wherein the flowing the at least a portion of the nitrogen into the electrochemical cell comprises bubbling air through an electrolyte of the electrochemical cell to saturate the electrolyte.

29.-41. (canceled)

42. The method of claim 1, wherein catalyst material comprises platinum; and
wherein the nitrogen-containing compound comprises nitrate formed directly from nitrogen oxidation.

43. The method of claim 22, wherein catalyst material comprises platinum; and
wherein the nitrogen-containing compound comprises nitrate formed directly from nitrogen oxidation.

44. A method of electrochemical nitrogen oxidation comprising:
reacting nitrogen in the presence of a platinum catalyst material at an electrochemical oxidative potential; and
forming nitrate from the nitrogen, oxygen and water.
